(19) United States
(12) Patent Application Publication
(10) Pub. No.: US 2019/0033891 A1
(43) Pub. Date: Jan. 31, 2019

(54) METHOD FOR CONTROLLING THE ATTITUDE GUIDANCE OF A SATELLITE, SATELLITE, PLURALITIES OF SATELLITES, AND ASSOCIATED COMPUTER PROGRAM

(71) Applicant: AIRBUS DEFENCE AND SPACE SAS, Les Mureaux (FR)

(72) Inventor: Emmanuel GIRAUD, TOULOUSE (FR)

(21) Appl. No.: 16/072,996

(22) PCT Filed: Feb. 13, 2017
(86) PCT No.: PCT/FR2017/050318

§ 371 Date: Jul. 26, 2018

(30) Foreign Application Priority Data
Feb. 16, 2016 (FR) 16 51237

(51) Int. Cl. G05D 1/08; B64G 1/24; B64G 1/44; B64G 1/10

(52) U.S. Cl. CPC G05D 1/0883; B64G 1/24; B64G 2001/1028; B64G 1/1021; B64G 2001/245; B64G 1/44

(57) ABSTRACT

Disclosed is a method for controlling the attitude guidance of a satellite with respect to an orbital reference system including a velocity axis, an orbital axis, and a Nadir axis; the satellite moving in the direction of the velocity axis, the satellite including an optical instrument having an observation axis, a solar generator defining a functional surface having a normal, an attitude control device, and a control unit. The method includes a step (104) of transmitting guidance commands so as to direct the observation axis of the optical instrument towards regions to be imaged or to orient the normal to the functional surface in the direction of the solar radiation. The guidance commands are commands to rotate the satellite about the velocity axis only, the angle of rotation about the orbital axis and Nadir axis within the orbital reference system being kept substantially at zero.

The invention relates to the domain of space, and the invention more particularly relates to guiding the attitude of one or more optical satellites orbiting a celestial body, in particular the Earth.

An optical satellite is a satellite that comprises an optical instrument and whose main purpose is related to this instrument. For example, this is a satellite whose purpose is to capture images of the surface of the Earth or of any other celestial body, for surveillance or mapping purposes.

An optical instrument for space missions is typically formed of at least one dioptric, catadioptric, or mirror lens having an optical axis, and a primary mirror for focusing the light rays, in order to obtain an image in a focal plane equipped with detection systems. The observation axis may be coincident with the optical axis of the lens or may form an angle with it by means of deflection mirrors. When the optical instrument is an image capturing instrument, meaning it comprises at least one sensor making it possible to form an image of a region, for example a region of the Earth's surface, the optical instrument also defines a field of view corresponding to the truncated cone extending from the functional surface of the sensor, meaning the surface of the sensor on which the images are formed, to the region being captured.

The satellite further comprises “secondary” equipment which contributes to the proper operation of the satellite in general, such as thrusters for correcting the path of the satellite, reaction wheels for modifying the angular orientation of the satellite, radiative panels for expelling heat, or a solar generator or battery for receiving and managing power.

The observation axis can be directed towards the area to be observed, by a movable deflection mirror in front of the telescope, while the satellite maintains a fixed orientation. This is the case for the SPOT 1 to 5 satellites. In these satellites, a swiveling solar generator pointing towards the sun is generally used. One disadvantage of these satellites of the prior art is that the presence of the deflection mirror which is movable relative to the satellite body decreases the quality of the captured image. The introduction of moving elements impacts the stability of the observation axis of the optical instrument. In addition, the presence of means for moving the movable deflection mirror increases the weight and bulk of the satellite, increasing its design and launch costs.

In more recent satellites such as the PLEIADES satellites, the satellite is oriented so that the telescope's observation axis is aimed at the area to be observed. In addition, the solar generator is fixed. We then speak of the attitude, or angular attitude, of the satellite as being the angular position of a reference system linked to the satellite with respect to an external reference system, for example linked to the orbit of the satellite.

These satellites can operate in two states: an operating state in which the optical instrument is used to capture an image, or in practice a succession of images, and a standby state in which the optical instrument is not being used. This standby state recharges the satellite's batteries. In this standby state, the attitude of the satellite is such that the fixed and planar solar panels are normal to the direction of the sun. PLEIADES satellites operate on this basis.

Between one state and the other, the attitude of the satellite and the orientation of its equipment are modified in the external reference system so as to optimize either the capturing of images or the recharging of batteries by orienting the generator perpendicularly to the sun's rays. In the case of a LEO (Low Earth Orbit), where the satellite is at an altitude where drag is significant, this change of orientation between the two operating states raises the issue of optimizing the surface areas in order to reduce drag. Indeed, to reduce drag, the frontal surface area of the satellite in the direction of its movement in orbit must be reduced. However, the smaller the surface area, the less area is available for attaching equipment. The two operating states imply that the front face of the satellite changes, meaning that several faces of the satellite must have their surface area reduced, which in practice reduces the possibility of reducing the drag of the satellite by changing its shape.

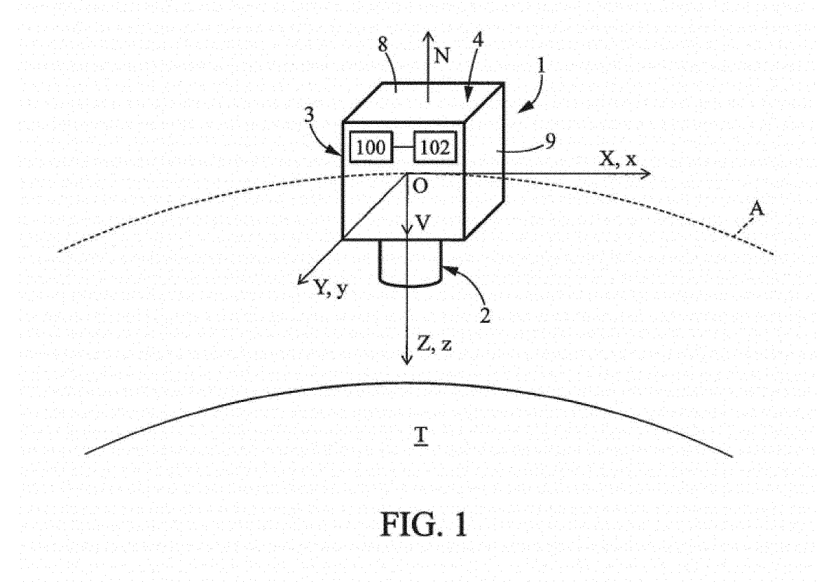

This type of satellite requires inertial attitude actuators (typically CMGs) operating around the three axes X, Y, Z, as can be seen in FIG. 1, to quickly direct the satellite towards the target area. These CMG actuators are expensive and heavy.

Document EP 2,489,593 describes a satellite of triangular cross-section and having solar generators on its sides which are rotatable in order to maximize solar collection.

There is therefore a need for a new method to overcome the above disadvantages of the prior art.

For this purpose, the object of the invention is a method for controlling the attitude guidance of a satellite with respect to an orthogonal orbital reference system comprising a velocity axis, an orbital axis, and a Nadir axis, along a portion of its orbit around the Earth, said orbit portion being illuminated by solar radiation; the satellite moving in the direction of the velocity axis, the satellite comprising a main body, an optical instrument having a fixed observation axis relative to the main body, at least one solar generator that is fixed relative to the main body and defining a functional surface whose normal has at least one component perpendicular to the velocity axis, at least one attitude control device, and a control unit connected to the attitude control device, said method comprising a first step (104) of transmitting guidance commands from the control unit to the attitude control unit so as to direct the observation axis of the optical instrument towards the regions to be imaged,

characterized in that the method further comprises a second step (106) of transmitting guidance commands from the control unit (102) to the attitude control unit (100) so as to orient the normal (N, Na, Nb) to the functional surface in the direction of the solar radiation, and the guidance commands of the first and second steps are commands to rotate the satellite about the velocity axis only, the angle of rotation about the orbital axis and Nadir axis within the orbital reference system being kept substantially at zero.

According to some particular embodiments, the artificial satellite comprises one or more of the following features:
the guidance commands comprise commands to rotate the satellite about the velocity axis over angular ranges in order to sweep a portion of the

Earth with the observation axis;
the method described above is implemented by multiple satellites;
the normal to the functional surface of the solar generator is parallel to the observation axis of the optical instrument and is oriented in the opposite direction;
the angles of rotation about the velocity axis are limited to a predetermined restriction angle, said guidance angle being defined relative to the orbital axis;
the restriction angle is 50°,
when there is no illumination on the satellite, for example during an eclipse, the satellite is rotated about the velocity axis so as to point the observation axis towards the Earth; and
the observation axis is perpendicular to the velocity axis;
the optical instrument comprises a lens with an optical axis parallel to the observation axis.
   The invention also relates to a satellite comprising a main body, an optical instrument whose observation axis is fixed relative to the main body, at least one solar generator that is fixed relative to the main body, at least one attitude control device and a control unit connected to the attitude control device, the control unit being able to execute the guidance control method according to any one of the preceding claims, the attitude control device being able to rotate the satellite about a first axis, a second axis, and a third axis, said first, second axis, and third axis being perpendicular to each other, said third axis being parallel to the observation axis of the optical instrument and oriented in the same direction, characterized in that the torque capacity of the attitude control device along the second axis and/or along the third axis is less than 40% of the torque capacity along the first axis.

According to some particular embodiments, the artificial satellite comprises one or more of the following features:
which comprises an interface device intended to engage with a complementary interface device of a launcher or satellite, and comprising an intermediate structure connecting the body of the satellite to the interface device, the observation axis of the optical instrument being oriented towards the interface device; and
the normal to the functional surface of the solar generator is parallel to the observation axis of the optical instrument and is oriented in the opposite direction.

The invention also relates to a plurality of satellites according to the features mentioned above. The plurality of satellites is intended to operate in a satellite constellation, said plurality of satellites being able to be guided in orbit by the method mentioned above.

Finally, the invention relates to a computer program product characterized in that it comprises a set of program code instructions which implement the above method when executed by a processor.

Other features and advantages of the invention will be apparent from the description of some embodiments accompanied by figures in which:

FIG. 1 is a schematic representation of a satellite orbiting the Earth and its local orbital reference system.

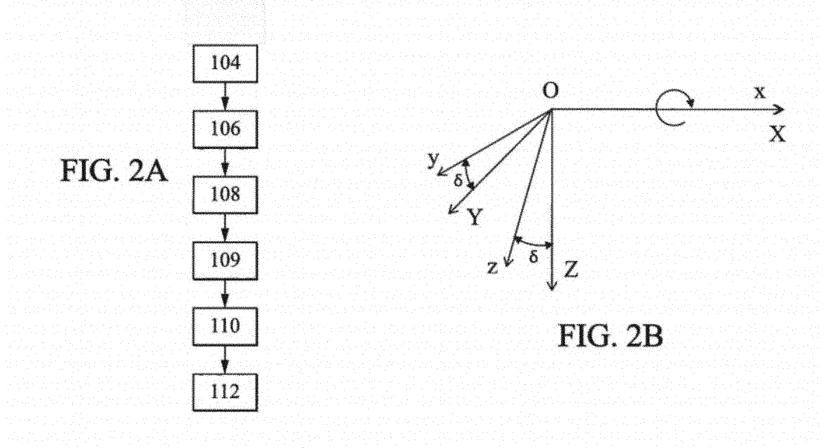

FIG. 2A is a flowchart showing the steps of the method according to the invention.

FIG. 2B is a diagram illustrating an exemplary rotation of a satellite guided by the method according to the invention.

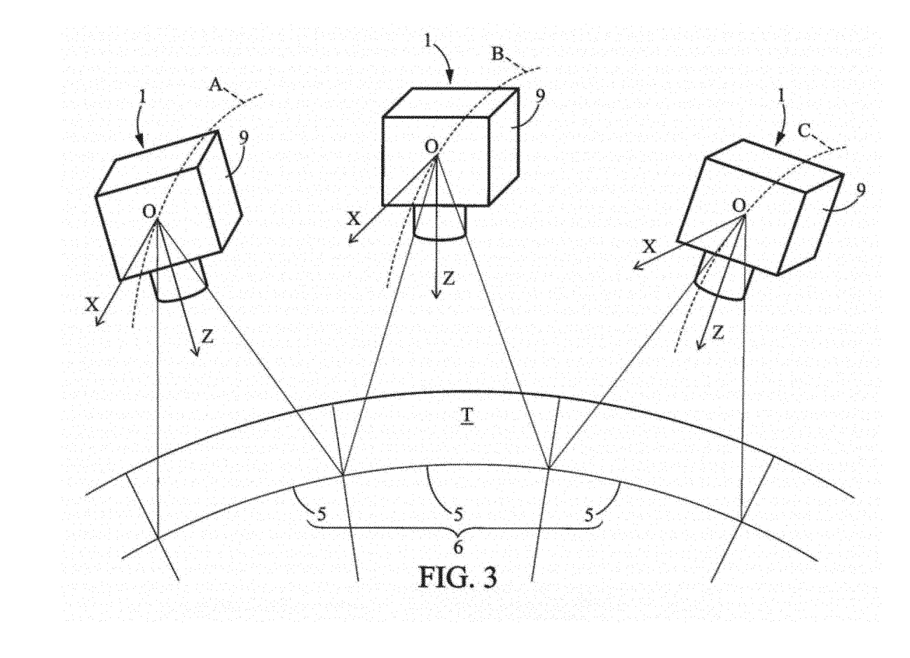

FIG. 3 is a schematic representation of three satellites of a constellation, guided by the method according to the invention in an image capturing state.

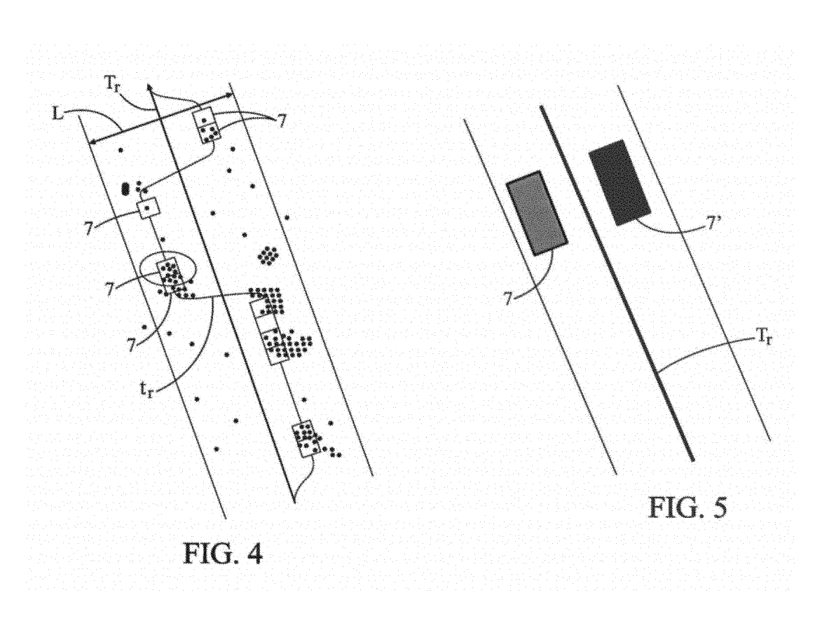

FIGS. 4 and 5 are diagrams illustrating examples of image capturing by one satellite (FIG. 4) and by two satellites (FIG. 5) guided by the method according to the invention.

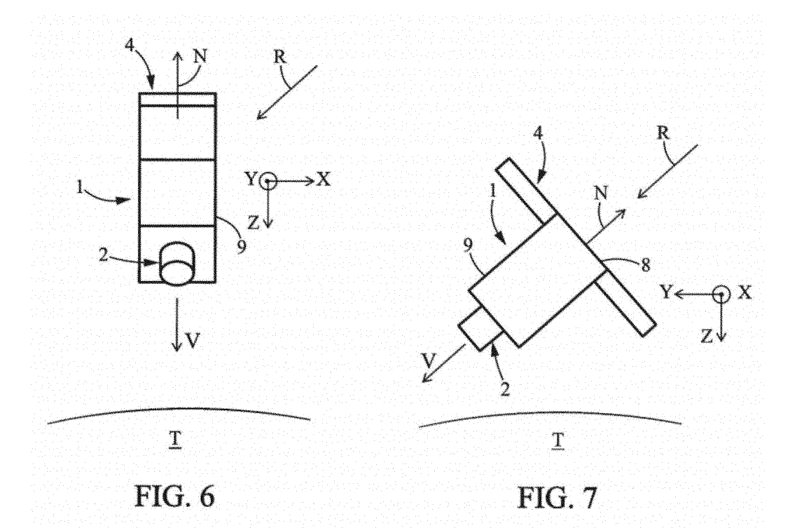

FIG. 6 is a schematic representation in the XZ plane of a satellite in a standby state.

FIG. 7 is a schematic plan view of the satellite of FIG. 6, in the YZ plane.

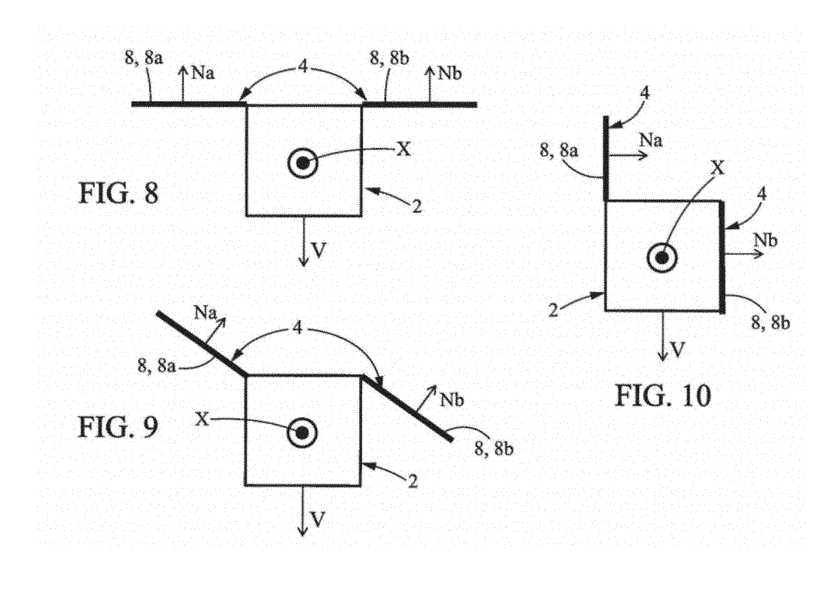

FIGS. 8 to 10 each represent an exemplary positioning of a solar generator on a satellite guided by the method according to the invention.

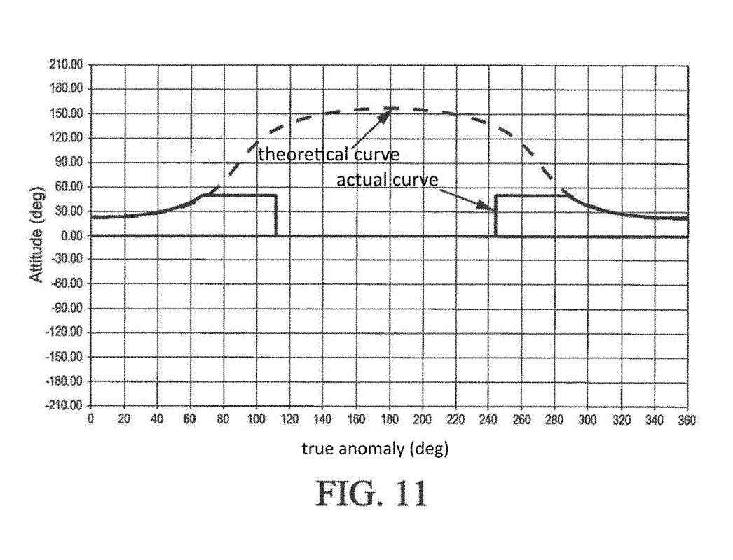

FIG. 11 is a graph illustrating the attitude of a satellite in a first positioning of the solar generator guided by the method according to the invention, in a standby state.

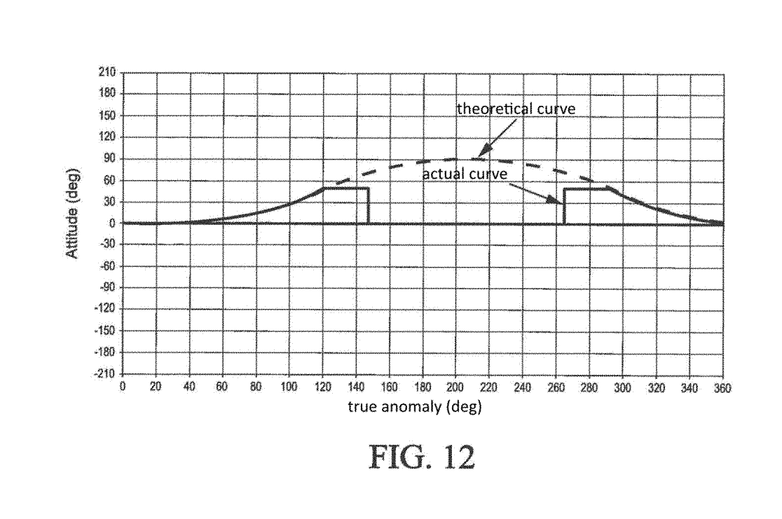

FIG. 12 is a graph illustrating the attitude of a satellite in a second positioning of the solar generator guided by the method according to the invention, in a standby state.

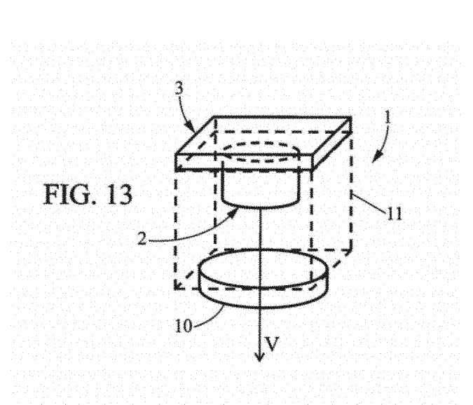

FIG. 13 is a schematic three-dimensional view of another exemplary design of a satellite guided by the method according to the invention.

FIG. 1 shows an example of an image capturing satellite 1 comprising an optical instrument 2, moving in an orbit A around a celestial body such as the Earth T.

Conventionally, the satellite 1 was previously placed in a launcher, which launches the satellite 1 into space. The satellite 1 is released into space by the launcher. Then it enters its planned operational orbit A.

According to the example in FIG. 1 but in a non-limiting manner, the satellite comprises a parallelepiped body 3 of center of gravity O and having four faces 9.

The optical instrument 2 is mounted on one of the faces 9 of the body 3 so as to be able to direct its observation axis V towards the Earth T in order to capture an image.

Two reference systems are defined for the satellite 1.

A first reference system OXYZ is linked to the orbit A of the satellite 1 at a given point, here the center of gravity O of the body 3, and is called the local orbital reference system. The local orbital reference system OXYZ is orthogonal, and comprises three axes:
an axis parallel to the velocity vector of the satellite 1 in its orbit A, denoted X and called the velocity axis,
an axis perpendicular to the plane of the orbit A, denoted Y and called the orbital axis, and
an axis pointing towards the main focus of the orbit A, meaning towards the Earth T, denoted Z and called the Nadir axis.

In the following, the attitude of the satellite 1 is defined as the movement of the satellite 1 within the local orbital reference system OXYZ.

A second reference system Oxyz is linked to the body 3 of the satellite 1 and its faces, and is called the satellite reference system. The satellite reference system Oxyz is orthogonal. It comprises a first axis x, a second axis y, and a third axis z. The third axis z is parallel to the observation axis (V) of the optical instrument (2) and is oriented in the same direction.

In the example of FIG. 1, the body 3 is parallelepiped, each axis being perpendicular to a face of the body 3 of the satellite.

In FIG. 1, the second reference system Oxyz has been represented in a position that is coincident with the first reference system OXYZ.

The optical instrument 2 is fixed relative to the body of the satellite 1, meaning that its observation axis V does not move relative to the satellite reference system Oxyz. To simplify the description, the satellite reference system Oxyz in the following is such that the z axis is coincident with the observation axis V of the optical instrument 2, and the x axis is coincident with the velocity axis X of the local orbital reference system. In FIG. 1, the observation axis and the optical axis of the lens are identical. They could be different, however, for example by using a fixed deflection mirror.

The satellite 1 also comprises a solar generator 4. The solar generator 4 is also fixed relative to the body 3 of the satellite, meaning that it is fixed relative to the satellite reference system. More specifically, the solar generator 4 has at least one functional surface, in other words a surface equipped to receive solar energy and convert it into energy usable by the satellite 1, oriented along a normal N. For example, the solar generator 4 is a solar panel. In the following, we speak of insolation to define the power received by the solar generator 4 and coming from solar radiation.

According to the example of FIG. 1, the normal N of the solar generator 4 is parallel to the Z axis, and oriented in the opposite direction to that of the observation axis V of the optical instrument 2. The normal N to the surface of the solar generator comprises at least one component perpendicular to the velocity axis X.

The satellite 1 further comprises an attitude control device 100 and a control unit 102 connected to this attitude control device 100.

The attitude control device comprises inertial actuators. These inertial actuators make it possible to set the body 3 of the satellite 1 into motion within the local orbital reference system Oxyz. These are reaction wheels or CMGs for example.

The inertial actuators of the attitude control device 100 are arranged perpendicularly to each other on the main body 3 of the satellite. Some inertial actuators enable rotating the satellite 1 about the first axis x. These are called actuators for the first axis x. Some inertial actuators enable rotating the satellite 1 about the second axis y. These are called actuators for the second axis y. Lastly, other inertial actuators enable rotating the satellite 1 about the third axis z. These are called actuators for the third axis z.

According to the invention, the inertial actuators for the second axis y and/or the actuators for the third axis z have a maximum torque capacity of less than 40% of the maximum torque capacity of the actuators for the first axis x. Preferably, the inertial actuators for the second axis y and/or for the third axis z have maximum torque capacities of less than 30% of the maximum torque capacity of the actuators for the first axis x.

In the present patent application, the torque capacity is the maximum torque that an inertial actuator can generate in order to rotate the satellite.

Advantageously, the inertial actuators for the second axis y and/or the actuators for the third axis z which are mounted in the satellite according to the invention are therefore smaller and lighter than the inertial actuators for these same axes mounted in prior art satellites.

More generally, the three actuators may be arranged differently, without being individually allocated to rotation on the x, y, or z axes. Thus, one or more of the three actuators may not be arranged on the x, y, and z axes.

A larger number of actuators may be used, for redundancy purposes. The maximum torque capacity along the second axis y and/or along the third axis z, however, will remain 40% less than the capacity along the first axis x, allowing the use of a cluster of actuators which is lighter than the prior art.

Preferably, the maximum torque capacity along the second axis y and/or along the third axis z is 30% less than the capacity along the first axis x.

The control unit 102 comprises a memory and a computing unit. This is a processor, for example.

The control unit 102 is able to implement the guidance method according to the invention.

With reference to FIG. 2A, the guidance method comprises a step 104 of transmitting guidance commands from the control unit 102 to the attitude control unit 100.

These guidance commands are defined by the control unit based on a maneuvering plan transmitted to the satellite by an operator located in a station on Earth or by control rules and/or tables defined according to the position of the sun relative to the orbit A. These control rules or tables are stored beforehand in the memory of the control unit or are transmitted to it by a ground operator.

According to the method of the invention, the guidance commands comprise commands for rotating the satellite 1 about the velocity axis X only, or in other words roll commands.

The rotation commands for controlling the attitude are zero about the orbital axis Y and Nadir axis Z. In practice, it is possible that the angle of rotation is non-zero about the orbital axis Y or Nadir axis Z due to residual errors from the attitude control rules and the presence of disruptive torque. However, these angles are negligible in such cases. These angles of rotation are for example less than 2 degrees and preferably less than 1 degree. The angle of rotation about the orbital axis Y and the Nadir axis Z within the orbital reference system is thus kept substantially at zero.

The transmission step 104 is continued by a step 106, during which the satellite pivots only about the velocity axis X so as to point the observation axis V towards a region to be imaged. In this position, the optical instrument captures one or more images of a region 7.

The surface area of the region to be imaged 7 is defined by the field of view of the optical instrument 2.

In a step 108, the control unit 102 sends a command to rotate about the velocity axis X only, in order to capture images of another portion of the Earth.

In a step 109, the satellite 1 is pivoted about the velocity axis X only, so that the observation axis V is directed towards the other portion of the Earth, to enable the optical instrument to capture images of another region 7.

In a step 110, the control unit 102 again transmits a guidance command to the attitude control device 100.

This guidance command minimizes the angle between the normal N of the functional surface of the solar generator 4 and the direction R of the rays from the sun, in order to obtain maximum insolation. This guidance command contains rotation about the velocity axis X only.

During a step 112, the satellite 1 rotates about the velocity axis X only. The satellite 1 is then in the standby state.

FIG. 2B schematically represents the attitude of the satellite 1 in the specific case of an initial state in which the satellite reference system Oxyz is coincident with the local orbital reference system OXYZ. In this diagram, a second position of the satellite 1 is represented in which it has rotated by an angle δ about the velocity axis X from the initial position, so that the y and z axes of the satellite reference frame are respectively displaced by an angle δ relative to the Y and Z axes of the local orbital reference system. The x axis of the satellite reference system is still coincident with the X axis of the local orbital reference system, because no rotation about the Y and Z axes has taken place.

Thus, according to the method of the invention, only rotations about the velocity axis X are performed by the satellite.

The result is a satellite of simplified design. In particular, the attitude control device only needs to be operational for rotation about the velocity axis X to guide the attitude of the satellite.

According to one embodiment of the invention, the satellite 1 is part of a satellite constellation, meaning a group of satellites 1 intended to work together to carry out a task. The satellites of the constellation whose attitude is guided by the method according to the invention may be identical, facilitating mass production without increasing costs.

For example, in FIG. 3, three satellites 1 of the same constellation are represented, each moving in a respective orbit A, B and C. The attitude of these satellites is guided by the control method according to the invention. By rotating the three satellites 1 only about their velocity axis X within defined angular ranges, and by considering their displacement in their orbit A, B, and C, the observation axis V of the optical instrument of each satellite is able to sweep a region of the ground 5 such that the three satellites 1 together can potentially capture an image of a larger region 6 of the ground.

FIG. 4 schematically represents various regions 7 of the ground which can be captured in an image by a satellite 1 moving in an orbit A corresponding to a path Tr along the ground. By rotating about the velocity axis X, the observation axis of the optical instrument 2 follows a path tr, contained within a strip on the ground of width L. When two regions 7, 7′ of the ground to be captured in an image are side by side, one on each side of the path of a satelliate 1 along the ground Tr, the satellite 1 captures a first region 7 of the ground and another satellite 1 in the same constellation can handle capturing the other region 7′. In the example of FIG. 3 the satellites are in the same orbit, but they may be in different orbits.

It is also possible to capture the same region or area from different angles, for example in order to obtain a stereo image.

Thus, by moving the satellite 1 only about the velocity axis X in the functional state, and considering a constellation of satellites, the results from the image capturing are at least equivalent to those of the prior art.

Since the optical instrument 2 does not need to include moving parts, the quality of the captured images is increased. The observation axis and the field of view of the optical instrument 2 are not displaced relative to the body 3 of the satellite. This stability improves the quality and therefore the accuracy of the images.

When the satellite 1 is in the standby state, the body 3 of the satellite 1 is rotated about the velocity axis X in order to orient the solar generator 4 towards the rays R from the sun. For example, the best position around the velocity axis X is calculated such that the angle between the normal N of the surface of the solar generator 4 and the direction R of the sun's rays is as small as possible. It is therefore not necessary to determine beforehand the position of the solar generator 4 on the body 3 of the satellite 1 as a function of its orbit, since the attitude guidance method optimizes insolation of the generator 4 by rotation about the velocity axis X. The same design can therefore be used for a constellation of satellites in sun-synchronous orbits (SSOs) with different local times at the ascending node.

According to one example (FIGS. 6 and 7), the solar generator 4 comprises at least one solar panel 8 whose functional surface, meaning the surface covered with solar cells, is oriented by the normal N. Thus, starting from the position of FIG. 1 for example, the satellite 1 is rotated about the velocity axis X to orient the normal N more or less parallel to the rays of direction R.

Depending on the position of the satellite in orbit A, the orientation of the direction R of the sun's rays varies. However, the solar generator 4 is fixed relative to the body 3 of the satellite, so that the normal N of the solar generator is almost never perfectly parallel to the direction R of the sun's rays. The solar generator 4 may then comprise a plurality of solar panels, each solar panel comprising a functional surface whose normal comprises at least one component perpendicular to the velocity axis X. The normal N of the functional surface of the solar generator 4, taken into account in calculating optimization in the standby state, can then be the mean normal of the normals of the solar panels, or can be coincident with at least one normal of the solar panels.

For example, the solar generator 4 may comprise two panels, respectively 8a and 8b, each having a functional surface with a normal, respectively Na and Nb. The two normals Na and Nb are preferably parallel to each other. For example, the two panels 8a, 8b are hung one on either side of a satellite face. At launch they preferably are in a folded configuration, and are deployed in orbit. The two panels may be aligned with this face of the satellite to form a plane (FIG. 8), or may be inclined with respect to this face (FIGS. 9 and 10). In general, each face of the solar panel 8 is always oriented so that it never has its normal oriented in a direction opposite to that of the normal of another panel, so that it is possible, by rotation about the velocity axis X, to find a position in which none of the panels 8a, 8b is shaded from the sun's rays.

Due to positioning the solar generator 4 in the standby state in order to optimize insolation, the power received by the solar generator 4 is on average greater than that received by a solar generator mounted on the body of a satellite with optimized initial calibration. For example, it has been established that for a solar generator 4 having a functional surface area of 2.4 m² mounted on a satellite 1 of sun-synchronous orbit, whose attitude is guided by the method according to the invention, in other words with rotation about the velocity axis X only, the power available at the satellite is between 230 W and 350 W, depending on the local time (LTAN) and the day of the year, while for a solar generator fixed on the body of the satellite so as to optimize insolation when pointing the optical axis of the lens of the instrument towards the Earth, the power generated is between 205 W and 310 W. Thus, by means of the method according to the invention, the maximum power generated is increased between 12% and 18%.

The method for controlling the attitude guidance of a satellite according to the invention allows any satellite, independently of its orbit characterized by its local time LTAN as well as the day of the year (solstices and equinoxes) in the case of a sun-synchronous orbit, to adjust the position of the satellite in the standby state in order to maximize insolation of its solar generator. Specifically, local time LTAN characterizes the inclination of the orbit of the satellite around the Earth T. Thus, for satellites whose orbit is characterized by a different local time LTAN, the solar generator 4 must be oriented differently to optimize its insolation in the standby state. With attitude guidance involving rotation about the velocity axis X only, it is sufficient to adjust the orientation of the satellite about the velocity axis X to maximize insolation of the solar group 4. The attitude guidance control method according to the invention makes it possible to have a satellite providing the expected functionalities with increased performance, in a simpler design. Because optimizing the insolation of the solar generator 4 is regulated solely by rotation about the velocity axis X, multiple satellites 1 having different orbits can have the same design, and in particular solar panels 8 mounted identically on the satellite body.

For a constellation in sun-synchronous orbits, it may be advantageous to adjust the angle of the solar generator according to the local time, in order to reduce roll attitude displacement.

FIGS. 11 and 12 are graphs each illustrating the attitude of a satellite in the standby state, guided by the method according to the invention, the x-axis indicating the true anomaly of the satellite orbiting the Earth, the y-axis indicating the angle of rotation of the satellite about the velocity axis X, the rotation about the Y and Z axes being practically zero.

The graph of FIG. 11 considers a satellite 1 whose solar generator 4 has its normal N opposite the observation axis V of the instrument 2—in this case referred to as a solar generator at zenith—as illustrated in FIG. 1 in particular, orbiting in a sun-synchronous orbit characterized by its local time (LTAN). From an initial position (true anomaly equal to 0), the satellite is rotated about its velocity axis X by an angle of 22.5° corresponding to the inclination of the satellite orbit for the local time of 10:30 a.m. As the satellite moves in its orbit and the true anomaly increases, the angle of rotation about the velocity axis X increases, in order to optimize insolation of the solar generator 4. However, preferably, once the rotation about the X axis has reached a determined value, 50° in the example of FIG. 11, the rotation can be restricted according to the stresses allowable in the satellite. The actual curve of the satellite attitude as a function of the true anomaly, a solid line, then deviates from the theoretical curve, a dashed line, the latter not taking into account the restriction. This restriction makes it possible in particular to protect other parameters of the satellite, and to avoid blinding sensitive equipment such as star sensors. When the satellite 1 is in the shadow of the Earth (starting at 110° of true anomaly in FIG. 11), it receives zero illumination from the sun, so that attempting to find illumination for the solar generator 4 is no longer appropriate, the recovered power being zero. The satellite 1 can then be rotated about the velocity axis X so as to reduce the angle of rotation about the velocity axis X to 0°, corresponding to a position in which the observation axis V is pointing towards the center of the Earth. Here again, the actual curve of the satellite attitude versus its true anomaly deviates from the theoretical curve. This alignment allows for example maintaining thermal stability of the optical instrument 2 and recovering some heat from the Earth. Then, once the satellite reenters a region (at about 245° of true anomaly in FIG. 11) illuminated by the sun, the rotation about the velocity axis X continues, first with a restriction to 50° for the same reasons as described above, then the actual curve rejoins the theoretical curve to optimize insolation of the solar generator 4.

In the graph of FIG. 12, another example of a satellite 1 is considered in which the solar generator 4 has its normal N forming an angle of 45° with respect to the normal of the preceding example—we then refer to a solar generator fixed at 45°—in particular, circulating in an orbit characterized by its local time (LTAN) at 9 a.m. In the initial position (true anomaly equal to)0°, the angle of rotation about the velocity axis X is zero, because the fixed 45° is optimized in this case for the LTAN orbit at 9 a.m. The satellite attitude about the velocity axis X evolves as before, with restriction to 50° and setting the angle of rotation about the velocity axis X to 0° when the satellite is in the Earth's shadow in order to preserve the optical instrument.

Guiding the satellite attitude only in rotation about the velocity axis X therefore simplifies the design of the satellite 1.

Thus, for example, the body 3 of the satellite always has the same front face 9, meaning the face perpendicular to the velocity axis X, so that it is possible to reduce the surface area of the front face in order to minimize drag, without impacting the rest of the body 3 of the satellite 1.

The design simplicity of the satellite, whose equipment does not comprise a moving part and which is provided with a simplified maneuvering device for the Y or Z orbital axes, has the effect of considerably lightening the satellite.

Thus, the inertia of the satellite 1 in rotation about the velocity axis X is reduced, allowing it to switch from the image capture state to the standby state with actuators of lower capacity than in maneuvering satellites of the prior art.

According to an exemplary embodiment of the satellite as shown in FIG. 13, the observation axis V of the optical instrument 2 is oriented towards a launcher interface device 10, such as a ring, intended to engage with a complementary interface device of a launcher and/or of another satellite. The launcher interface device 10 is generally a ring. Schematically, the body of the satellite is represented as being reduced to a plate 3 connected to the ring 10 by a structure 11. The optical instrument 2 is rigidly fixed to the plate 3 inside the structure 11. The observation axis V of the optical instrument 2 is then oriented from the upper end to the lower end of the intermediate structure 11, towards the launcher interface ring 10. The intermediate structure 11 may form an enclosure which houses the optical instrument 2. The satellite 1 may be mounted in a launcher by engaging the ring 10 with a complementary ring of a launcher, or it may be stacked on a satellite by engaging the ring 10 with a complementary device of the other satellite.

This design makes it possible to have a more compact satellite 1, further reducing its inertia when guiding its attitude. This design also serves to attenuate vibrations transmitted from the launcher via the satellite interface ring 10, in order to protect the optical instrument 2. Indeed, the optical instrument 2 is distanced from the interface ring 10 due to the intermediate structure 11, the latter at least partially absorbing the vibrations before they reach the body 3 and the optical instrument 2.

In addition, this targeted design makes the satellite particularly suitable for stacking satellites in a launcher for a multiple launch, for example as part of a satellite constellation. However, the space available in a launcher under the nosecone is generally limited, and restricts the number of satellites that can be stacked. Because of the compactness, for a given launcher, a stack of satellites of this design may contain a larger number of satellites than with satellites of the prior art.

1. Method for controlling the attitude guidance of a satellite (1) with respect to an orthogonal orbital reference system (OXYZ) comprising a velocity axis (X), an orbital axis (Y), and a Nadir axis (Z), along a portion of its orbit (A) around the Earth (T), said orbit portion (A) being illuminated by solar radiation; the satellite moving in the direction of the velocity axis (X), the satellite (1) comprising a main body (3), an optical instrument (2) having a fixed observation axis (V) relative to the main body (3), at least one solar generator (4) that is fixed relative to the main body (3) and defining a functional surface whose normal (N, Na, Nb) has at least one component perpendicular to the velocity axis (X), at least one attitude control device (100), and a control unit (102) connected to the attitude control device (100), said method comprising a first step (104) of transmitting guidance commands from the control unit (102) to the attitude control unit (100) in order to direct the observation axis (V) of the optical instrument towards the regions (7) to be imaged,
wherein the method comprises a second step (104) of transmitting guidance commands from the control unit (102) to the attitude control unit (100) so as to orient the normal (N, Na, Nb) to the functional surface in the direction of the solar radiation, and
wherein the guidance commands of the first and second steps are commands to rotate the satellite about the velocity axis (X) only, the angle of rotation about the orbital axis (Y) and the Nadir axis (Z) within the orbital reference system being kept substantially at zero.

2. Method according to claim 1, wherein the guidance commands comprise commands to rotate the satellite (1) about the velocity axis (X) over angular ranges in order to sweep a portion of the Earth with the observation axis (V).

3. Method according to claim 1, implemented by multiple satellites (1).

4. Method according to claim 1, wherein the normal (N, Na, Nb) to the functional surface of the solar generator (4) is parallel to the observation axis (V) of the optical instrument (2) and is oriented in the opposite direction.

5. Method according to claim 1, wherein the angles of rotation about the velocity axis (X) are limited to a predetermined restriction angle, said guidance angle being defined relative to the orbital axis (Y).

6. Method according to claim 5, wherein the restriction angle is 50°.

7. Method according to claim 1, wherein when there is no illumination on the satellite (1), the satellite (1) is rotated about the velocity axis (X) so as to point the observation axis (V) towards the Earth (T).

8. Method according to claim 1, wherein the observation axis (V) is perpendicular to the velocity axis (X).

9. Method according to claim 1, wherein the optical instrument comprises a lens with an optical axis parallel to the observation axis.

10. Satellite (1) comprising a main body (3), an optical instrument (2) whose observation axis (V) is fixed relative to the main body (3), at least one solar generator (4) that is fixed relative to the main body (3), at least one attitude control device (100) and a control unit (102) connected to the attitude control device (100), the control unit (102) being able to execute the guidance control method according to claim 1, the attitude control device (100) being able to rotate the satellite (1) about a first axis (x), a second axis (y) , and a third axis (z), said first (x), second axis (y), and third axis (z) being perpendicular to each other, said third axis (z) being parallel to the observation axis (V) of the optical instrument (2) and oriented in the same direction, wherein the torque capacity of the attitude control device (100) along the second axis (y) and/or along the third axis (z) is less than 40% of the torque capacity along the first axis (x).

11. Satellite (1) according according to claim 10, comprising an interface device (10) intended to engage with a complementary interface device of a launcher or satellite, and comprising an intermediate structure (11) connecting the body (3) of the satellite (1) to the interface device (10), the observation axis (V) of the optical instrument (2) being oriented towards the interface device (10).

12. Satellite (1) according to claim 10, wherein the normal (N, Na, Nb) to the functional surface of the solar generator (4) is parallel to the observation axis (V) of the optical instrument (2) and is oriented in the opposite direction.

13. Plurality of satellites according to claim 10, constructed and arranged to operate in a satellite constellation, said plurality of satellites being able to be guided in orbit by the method.

14. A non-transitory computer-readable medium on which is stored a computer comprising a set of program code instructions that implement a method according to claim 1 when executed by a processor.

15. Method according to claim 2, implemented by multiple satellites (1).

16. Method according to claim 2, wherein the normal (N, Na, Nb) to the functional surface of the solar generator (4) is parallel to the observation axis (V) of the optical instrument (2) and is oriented in the opposite direction.

17. Method according to claim 3, wherein the normal (N, Na, Nb) to the functional surface of the solar generator (4) is parallel to the observation axis (V) of the optical instrument (2) and is oriented in the opposite direction.

18. Method according to claim 2, wherein the angles of rotation about the velocity axis (X) are limited to a predetermined restriction angle, said guidance angle being defined relative to the orbital axis (Y).

19. Method according to claim 3, wherein the angles of rotation about the velocity axis (X) are limited to a predetermined restriction angle, said guidance angle being defined relative to the orbital axis (Y).

20. Method according to claim 4, wherein the angles of rotation about the velocity axis (X) are limited to a predetermined restriction angle, said guidance angle being defined relative to the orbital axis (Y).
